(19) United States
(12) Patent Application Publication
(10) Pub. No.: US 2002/0159856 A1
(43) Pub. Date: Oct. 31, 2002

(54) Fastening means

(76) Inventor: Reinhard Buhri, Frastanz (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/132,631

(22) Filed: Apr. 24, 2002

(30) Foreign Application Priority Data
Apr. 30, 2001 (DE) 10121269.0

(51) Int. Cl. F16B 39/00

(52) U.S. Cl. 411/107

(57) ABSTRACT

A fastening means that can be driven into a pre-fabricated bore hole in a hard substrate such as steel, concrete, rock or the like using a setting tool. The fastening means comprises a shank (1) and a load application means (2), wherein the shank (1) has a free end that is planar and a cylindrical outer contour, such that the driving of the fastening means into the substrate is done with an essentially consistently uniform driving force.

### BACKGROUND OF THE INVENTION

The invention relates to a fastening means for driving into a pre-drilled bore hole, in a hard substrate, using a setting tool that is driven by highly compressed gases. Particularly, the fastening means comprises a shank and a load application means, wherein the shank (1, 11, 21) includes a free end that is planar end and an outer contour that is cylindrical.

Fastening means serve in fixing structural components to hard substrates such as steel, concrete, rock or the like. Said fastening means can be driven into the substrate with the help of a suitable setting tool. One such fastening means intended particularly for use in concrete and rock is, for example, disclosed in DE 1 625 383. That fastening means has a shank with a large length and a setting-side planar face and a load application means that connects to the shank end opposite the setting-end. Particularly, in a substrate that is formed of a steel structural component, the use of this fastening means has the disadvantage that with a relatively minimal wall thickness, the free end of the shank in the driven in, set condition of the fastening means protrudes on the rear side of the steel structural component. This generally results in damage to any paint or covering on the steel structural component, such as an anti-corrosion treatment, on the generally inaccessible side of the steel structural component.

The object of the invention is to create a fastening means that can be anchored satisfactorily and securely in a pre-drilled hole in a hard substrate, in particular one comprised of steel, with a relatively minimal wall thickness, without causing damage to the side of the substrate opposite to the fastening means.

### SUMMARY OF THE INVENTION

The object is achieved by a fastening means comprising a shank and a load application means, wherein the shank includes a free end that is planar end and an outer contour that is cylindrical.

As a result of the cylindrical external contour of the shank, the shank of the fastening means may be driven into the pre-fabricated bore hole, whose internal diameter is 2% to 25% smaller than the diameter of the shank, using an almost uniform driving-in force.

A circumferential insertion slope is, preferably, in the coaxial alignment of the shank facing the pre-fabricated bore hole, said insertion slope enveloping the circumference of the shank at its free, planar end. For example, the smallest diameter of the insertion slope is smaller than the inside diameter of the bore hole.

Preferably, the shank has a cross-section that is 0.33 to 1.5 times the length of the shank. In this fashion, for example, the fastening means with a short shank length can have a shank with a large cross-section so that a contact surface cooperating with the substrate may be as large as in the fastening means whose shank exhibits a large length but a smaller cross-section.

A limitation of the driving-in force of the fastening means can, on the one hand, be achieved by appropriate adjustment of the stroke of the drive cylinder of a setting tool, the depth of the pre-fabricated bore hole, or the axial support of the load application means at the surface of the substrate. The outer contour of the shank is preferably overlapped radially by the outer contour of the load application means so that the axial support of the load application means can rest on the surface. The length of the load application means has, for example, a length that is 0.15 to 8 times the length of the shank.

Particularly, when fastening structural components to the substrate which, after setting of the fastening means, must be generally secure but rotational around the longitudinal axis of the fastening means, it is advantageous if the load application means tapers stepwise towards the shank. This stepwise tapering can be achieved in that, on the one hand, the cross-section of the steplike tapering corresponds essentially to the cross-section of a bore hole in the structural component and, on the other hand, the length of the steplike tapering is matched essentially to the wall thickness of the structural component in the area of the bore hole.

In special cases it is possible that the structural components to be secured to the substrate, for example, to a ceiling, have a very small circumference or a small external diameter but a large length and, consequently, are very heavy. With the aid of a fastening means, that expediently provides a load application means whose cross-section is smaller than the cross-section of the shank, on the one hand, a satisfactory connection of the fastening means with the component to be fastened is established and, on the other hand, the large shank cross-section provides a secure anchoring of the fastening means in the substrate.

A rapid, secure, and removable connection between the fastening means and the substrate is achieved practically in that the load application means of the fastening means is provided with an external, male screw thread or with an internal, female screw thread.

A satisfactory connection of the shank with the substrate is preferably achieved with a shank whose external contour is provided with a profile.

### BRIEF DESCRIPTION OF THE DRAWINGS

The invention is more completely described read together with drawings, which represent a preferred exemplary embodiment, wherein:

FIG. 1 illustrates a fastening means, according to the invention, in which the load application means is provided with an external, male screw thread;

FIG. 2 illustrates a further fastening means, according to the invention, in which the load application means is provided with an internal, female screw thread;

FIG. 3 illustrates still a further fastening means, according to the invention, in which the load application means is provided with an external, male screw thread and has a smaller cross-section than the shank.

### DETAILED DESCRIPTION OF THE INVENTION

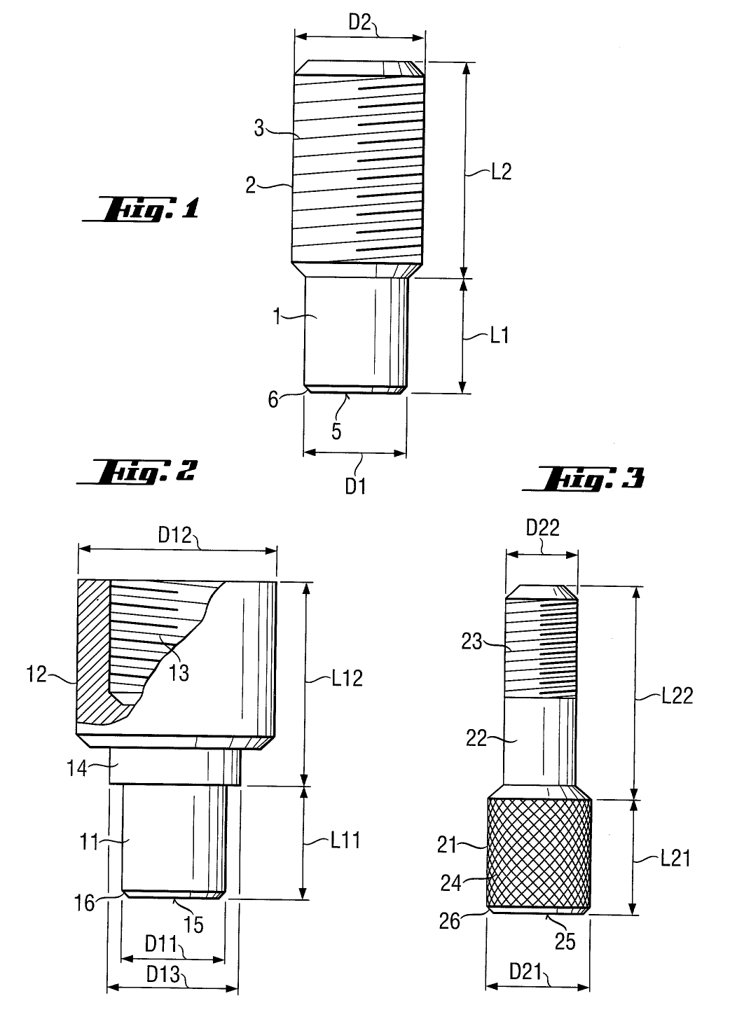

The fastening elements, according to the invention, and represented in FIGS. 1 to 3, may be driven into a pre-fabricated bore hole (not shown) in a hard substrate (also not shown) such as concrete, rock, steel or the like using a setting device driven by highly compressed gases. The internal diameter of the bore hole is smaller than the cross-section of a shank 1, 11, 21, which is present in each of the fastening means, as shown in FIGS. 1 to 3, respectively. In addition to the shank 1, 11, 21, each of the fastening means, as shown in FIGS. 1 to 3, respectively, has a load application means 2, 12, 22, wherein the length L1, L11, L21 of the shank 1, 11, 21 is shorter than the length L2, L12, L22 of the load application means 2, 12, 22. The shank 1, 11, 21 has at its free end a planar face 5, 15, 25 with an insertion slope 6, 16, 26 and has a cylindrical outer contour. The length L1, L11, L21 of the shank 1, 11, 21 is 0.4 to 0.7 times the length L2, L12, L22 of the load application means 2, 12, 22.

In the fastening means represented in FIGS. 1 and 2, respectively, the cross-section D2, D12 of the load application means 2, 12 is larger than the cross-section D1, D11 or the shank 1, 11. The load application means 1, 12, 22 is, for example, provided partially with an external, male screw thread 3, 23, as shown in FIG. 1 and 3, respectively, or with an internal, female screw thread 13, as shown in FIG. 2. In addition, FIG. 2 discloses a fastening means, in which the load application means 12 tapers stepwise in the direction of the shank 11. The stepwise tapering 14 has a cross-section D13 that corresponds to 0.5 to 2 times the cross-section of the shank 11.

FIG. 3 discloses a fastening means, in which the cross-section D22 of the load application means 22 is smaller than the cross-section D21 of the shank 12. In all of the fastening means according to the invention, as represented in FIGS. 1 to 3, respectively, the shank 1, 11, 21 may be with profiling 24. The profiling 24, as represented in FIG. 3, can, for instance, be a longitudinal or cross-hatched edge milling. It is also possible for the cross-section of the shank and of the load application means to be of the same dimensions. The fastening means are, for example, manufactured of a metal material, particularly of steel or non-rusting steel.

What is claimed is:

1. A fastening means for driving into a pre-drilled bore hole, in a hard substrate selected from the group concrete, rock, steel and the like, using a setting tool that is driven by highly compressed gases, said fastening means comprising a shank (1, 11, 21) and a load application means (2, 12, 22), wherein the shank (1, 11, 21) includes a free end that is planar and an outer contour that is cylindrical.

2. The fastening means of claim 1, wherein the free end of the shank (1, 11, 21) has a circumference including a circumferential insertion slope (6, 16, 26).

3. The fastening means of claim 1, wherein the shank (1, 11, 21) has a cross-section that corresponds to 0.33 to 2 times the length (L1, L11, L21) of the shank (1, 11, 21).

4. The fastening means of claim 1, wherein the load application means (2, 12, 22) has an outer contour that overlaps the outer contour of the shank (1, 11, 21).

5. The fastening means of claim 4, wherein the load application means (12) tapers stepwise towards the shank (11).

6. The fastening means of claim 3, wherein the cross-section (D22) of the load application means (22) is smaller than a cross-section (D21) of the shank (12).

7. The fastening means of claim 1, wherein the load application means (2, 22) includes at least partially an external, male screw thread (2, 23).

8. The fastening means of claim 1, wherein the load application means (12) includes an internal, female screw thread (13).

9. The fastening means of claim 1, wherein the outer contour of the shank (21) includes profiling (24).
